(19) United States
(12) Patent Application Publication
(10) Pub. No.: US 2012/0287169 A1
(43) Pub. Date: Nov. 15, 2012

(54) LED DISPLAY DEVICE AND MANUFACTURING METHOD THEREOF

(75) Inventors: SUNG-HSIANG YANG, Chu-Nan (TW); CHAO-FA PENG, Chu-Nan (TW); LUNG-YU HUNG, Chu-Nan (TW); CHIEN-SHANG HSIEH, Chu-Nan (TW); WEI-CHUN YEH, Chu-Nan (TW); SHENG-HSIANG KUNG, Chu-Nan (TW); KUO-CHENG CHANG, Chu-Nan (TW)

(73) Assignee: FOXSEMICON INTEGRATED TECHNOLOGY, INC., Chu-Nan (TW)

(21) Appl. No.: 13/209,454

(22) Filed: Aug. 15, 2011

(30) Foreign Application Priority Data
May 12, 2011 (TW) 100116594

(51) Int. Cl. G09G 3/32; H01J 9/24; G09G 5/10; F21S 4/00

(52) U.S. Cl. 345/690; 362/249.02; 445/24; 345/82

(57) ABSTRACT

An LED displaying device includes a first transparent substrate, LEDs and a second transparent substrate. The first transparent substrate includes a circuit structure formed thereon. The LEDs are mounted on the first transparent substrate and electrically connected to the circuit structure. The second transparent substrate is covered on the LEDs.

### BACKGROUND

1. Technical Field

The disclosure relates to LED display devices, and particularly to an LED display device with high light extracting efficiency.

2. Description of the Related Art

Light emitting diodes (LEDs) have many advantages, such as high luminosity, low operational voltage, low power consumption, compatibility with integrated circuits, easy driving, and environmental friendliness. Such advantages have promoted the wide use of LEDs as a light source. Now, LEDs are commonly applied in display devices.

A conventional LED display device includes a printed circuit board with a plurality of LEDs mounted thereon, a transparent cover mounted on a front side of the printed circuit board and a back plate mounted on a rear side of the printed circuit board. The printed circuit board includes a plurality of opaque circuit layers stacked together. The back plate connects the transparent cover for sealing the printed circuit board and the LEDs therebetween, thereby protecting the LEDs from dust and dirty. However, due to the printed circuit board is opaque, a portion of light emitted from the LEDs incident on the printed circuit board needs to be reflected many times before emitting out of the LED display device and another portion of light emitted from the LEDs incident on the printed circuit board can be absorbed by the printed circuit board, such that a light extracting efficiency of the LED display device is adversely affected.

What is desired, therefore, is an LED display device which can overcome the above-described shortcomings.

### BRIEF DESCRIPTION OF THE DRAWINGS

FIG. 1 is a schematic, assembled view of an LED display device in accordance with an exemplary embodiment, wherein the LED display device includes a first transparent substrate, a second transparent substrate, and a plurality of LEDs mounted between the first and second transparent substrates.

FIG. 2 is an exploded view of the LED display device of FIG. 1.

FIG. 3 is a schematic, side view, in an enlarged scale, of a portion of the first transparent substrate.

FIG. 4 is a schematic view, in an enlarged scale, of a portion of a circuit structure of the first transparent substrate of the LED display device of FIG. 1.

FIG. 5 is a schematic, cross-section, in an enlarged scale, of a first transparent substrate of an LED display device according to a second exemplary embodiment.

### DETAILED DESCRIPTION

Embodiments of an LED display device as disclosed are described in detail here with reference to the drawings.

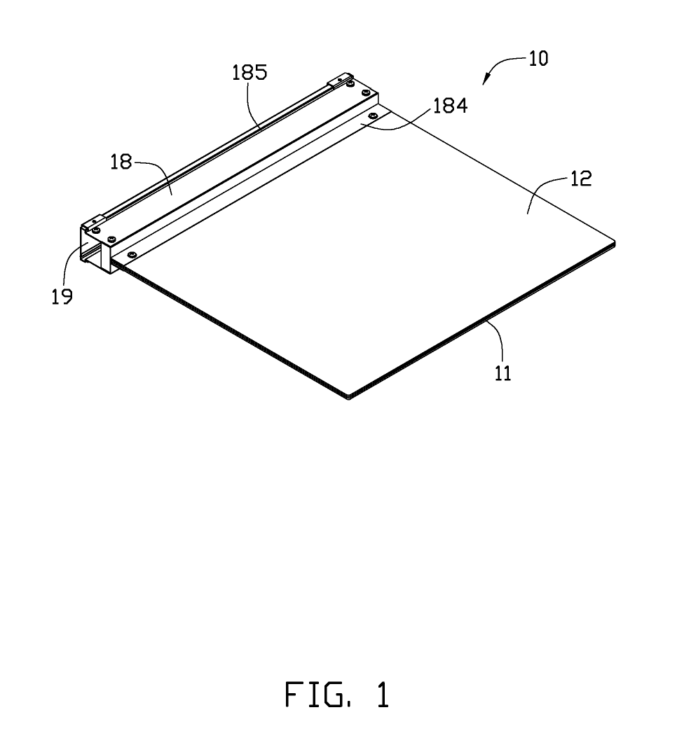

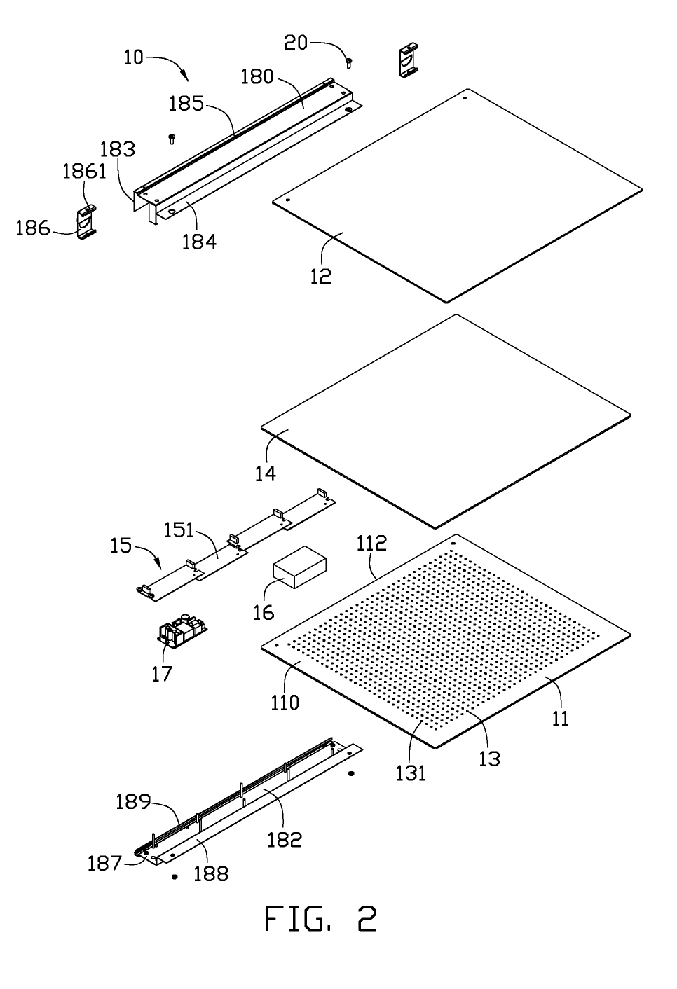

Referring to FIGS. 1 and 2, an LED display device 10 in accordance with one embodiment of the disclosure includes a first transparent substrate 11, a second transparent substrate 12, an LED light source 13, an affixing layer 14, a drive unit 15, a control unit 16, a power source 17 and a fixing frame 18.

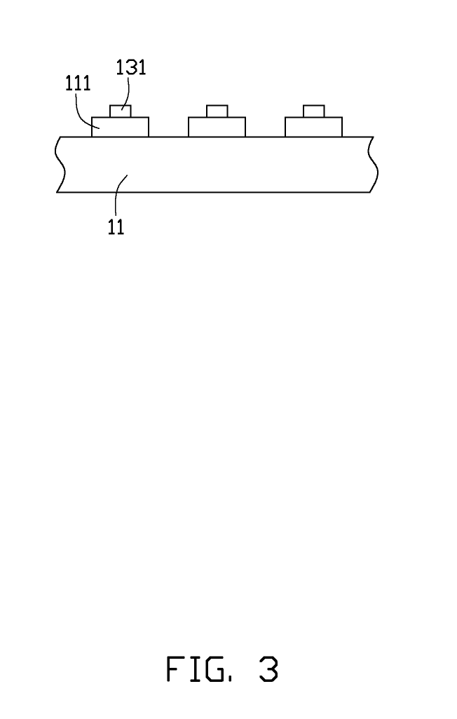

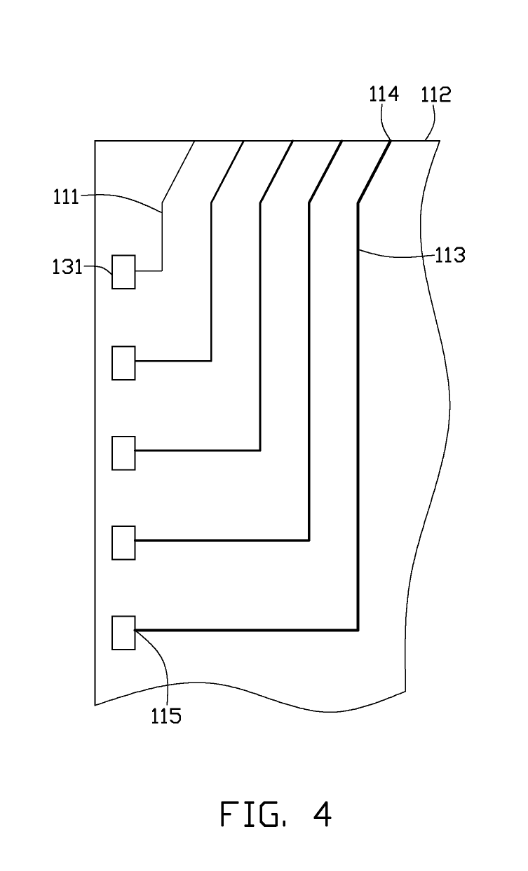

The first transparent substrate 11 is substantially rectangular, and includes a main plate 110 and a connecting interface 112 at one periphery side of the main plate 110. The first transparent plate 11 is made of transparent material, such as glass or plastic. Referring also to FIGS. 3 and 4, the main plate 110 includes a circuit structure 111 formed thereon. The circuit structure 111 includes a plurality of circuit wires 113 layered on a top surface of the first transparent substrate 11. The circuit wires 113 are made of electric conductive material, such as gold, sliver, copper, iron, aluminum, platinum, lead, tin, conductive metal paste, etc. In this embodiment, the first transparent plate 11 is made of glass, the circuit structure 111 is made of conductive silver paste, and the circuit structure 111 is formed on the first transparent substrate 11 by screen printing.

The LED light source 13 includes a plurality of LEDs 131 arranged in a matrix and mounted on the top surface of the main plate 110. The circuit wires 113 of the circuit structure 111 are electrically connected between the connecting interface 112 and the LEDs 131. The circuit wires 113 are parallel to each other. Referring to FIG. 3, each of the circuit wires 113 has a first end 114 connected with the connecting interface 112 and an opposite second end 115 connected with one corresponding LED 131.

The first ends 114 of the circuit wires 113 are equally spaced from each other along the connecting interface 112. A distance between each two neighboring second ends 115 is larger than that of each two neighboring first ends 114, and the distances between each two neighboring second ends 115 are gradually increased along a direction away from the connecting interface 112. With such a configuration, an impedance of the second ends 115 of the circuit wires 111 which are located far away from the connecting interface 112 can be substantially equal to that of the second ends 115 which are located adjacent to the connecting interface 112. Thus, an intensity of light emitted from a portion of the LEDs 131 which are located far away from the connecting interface 112 can be substantially the same as an intensity of light emitted from the other portion of the LEDs 131 which are located adjacent to the connecting interface 112. In other words, intensity of light emitted from each of the LEDs 131 is substantially equal to each other.

The second transparent substrate 12 is similar to the first transparent substrate 11. The second transparent substrate 12 is substantially rectangular, and made of transparent material, such as glass or plastic. The second transparent substrate 12 is different from the first transparent substrate 11 in that the second transparent substrate 12 has no circuit structure 111 formed thereon. The second transparent substrate 12 covers the LEDs 131.

The affixing layer 14 is interconnected between the first transparent substrate 11 and the second transparent substrate 12. The affixing layer 14 is made of polyvinyl butyral resin or ethylene-vinyl acetate copolymer. The affixing layer 14 is configured to fill in an air clearance defined between the first and the second transparent substrates 11, 12 when the first and the second transparent substrates 11, 12 are connected together.

The diver unit 15 includes a plurality of flexible printed circuit boards 151 with diver circuit formed therein. The diver unit 15 is mounted on the connecting interface 112 of the first transparent substrate 11, and the diver circuit electrically connects with the circuit structure 111 of the first transparent substrate 11.

The control unit 16 is electrically connected with the drive unit 15. The control unit 16 is configured to receive a signal containing displaying message and output the signal to the drive unit 16, such that the LEDs 131 can emit light in a controlled manner for showing the message thereby. The control unit 16 receives the signal via wireless transmission, such as general packet radio service, wireless fidelity, blue tooth, etc. Alternatively, the control unit 16 can include an SD card for storing multiple displaying programs therein.

The AC-DC convertor 17 is electrically connected between an outer power source and the control unit 16. The AC-DC convertor 17 is used to convert an AC voltage obtained from the outer power source to a DC voltage and then supply the DC voltage to the control unit 16.

The fixing frame 18 includes a first fixing plate 181, a second fixing plate 182 and a plurality of fastening elements 186. Each of the first fixing plate 181 and the second fixing plate 182 is elongated, and has a generally L-shaped cross-section. The first fixing plate 181 includes a top wall 180, a side wall 183 extending downward from a long side of the top wall 180, and a first connecting wall 184 extending outward from another long side of the top wall 180. The top wall 180 defines a first engaging groove 185 at a top surface along a lengthwise direction thereof. The second fixing plate 182 includes a bottom wall 187 and a second connecting wall 188 extending outward from a long side of the bottom wall 187. The bottom wall 187 defines a second engaging groove 189 at a bottom surface along a lengthwise direction thereof.

Each of the fastening elements 186 is about U-shaped, and includes two engaging plates 1861 formed at two opposite distal ends thereof. When the fixing frame 18 is assembled, the top wall 180 of the first fixing plate 181 is parallel to and spaced from the bottom wall 187 of the second fixing plate 182, and a bottom of the side wall 183 of the first fixing plate 181 connects with the bottom wall 187. The first fixing plate 181 and the second fixing plate 182 cooperatively define a rectangular receiving room 19 receiving the AC-DC convertor 17, the control unit 16 and the drive unit 15 therein. The first engaging groove 185 and the second engaging groove 189 are aligned with each other. Each of the fastening elements 16 connects the first fixing plate 181 with one of the engaging plates 1861 engaged in the first engaging groove 185, and connects the second fixing plate 182 with the other engaging plate 1861 engaged in the second engaging groove 189. The first connecting wall 184 and the second connecting wall 188 are parallel to and spaced from each other. A distance between the first connecting wall 184 and the second connecting wall 188 is substantially equal to a sum of thicknesses of the first and second transparent substrates 11, 12.

In assembling, the first connecting wall 184 and the second connecting wall 188 abut a top surface of the second transparent substrate 182 and a bottom surface of the first transparent substrate 181, respectively; then screws 20 are extended through the first connecting wall 184, the second transparent substrate 182, the first transparent substrate 11 and the second connecting wall 12 in sequence to thereby connect the first transparent substrate 11, the second transparent substrate 12 and the fixing frame 18 together.

Due to the first transparent substrate 11 and the second transparent substrate 12 which sandwich the LEDs 131 therebetween are both made of transparent material, light emitted from the LEDs 131 incident on the first transparent substrate 11 and the second transparent substrate 12 can directly transmit through the first transparent substrate 11 and the second transparent substrate 12 without multi-reflection, respectively, such that the LED display device 10 has a high light extracting efficiency. In addition, the first transparent substrate 11 and the second transparent substrate 12 both allow light to pass therethrough, such that the LED display device 10 in whole is luminous to have better visual effects.

A method of manufacturing the LED display device 10 includes following steps:

The first step is to provide the first transparent substrate 11 with the circuit structure 111 formed thereon. The circuit structure 111 includes a plurality of circuit wires 113 which are formed on the first transparent substrate 11 by screen printing of conductive silver paste.

The second step is to mount the LEDs 131 on the first transparent substrate 11 in a matrix.

The third step is to provide the second transparent substrate 12 covered on the LEDs 131 via the affixing layer 14.

The fourth step is to provide the drive unit 15, the control unit 16, the AC-DC convertor 17 and the fixing frame 18. The drive unit 15, the control unit 16 and the AC-DC convertor 17 are connected to the first transparent substrate 11 and the second transparent substrate 12 via the fixing frame 18.

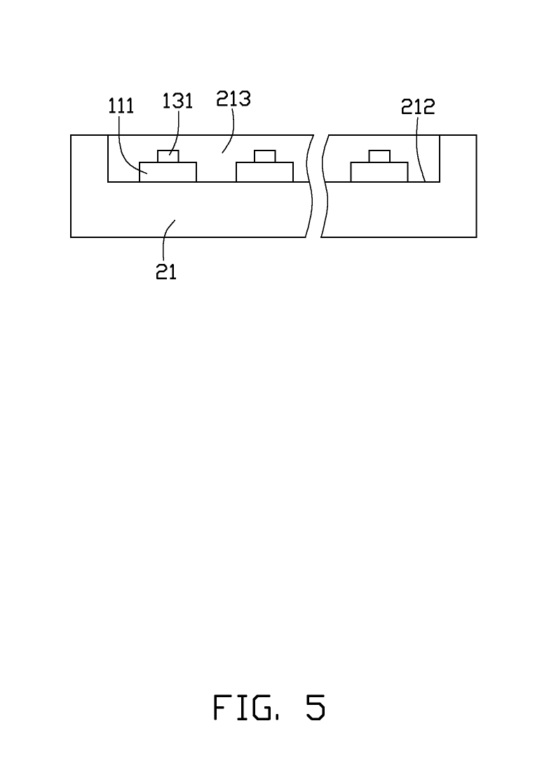

Referring to FIG. 5, a first transparent substrate 21 according to a second exemplary embodiment is shown. The first transparent substrate 21 differs from the first transparent substrate 11 of the first embodiment only in that: a receiving concave 213 is concaved inwards from a central portion of a top surface of the first transparent substrate 21. The circuit structure 11 is formed on a supporting surface 212 of the first transparent substrate 11 which is located at a bottom of the receiving concave 213. The LEDs 131 are disposed in the concave 213, mounted on the supporting surface 212 and electrically connected to the circuit structure 11.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. An LED displaying device, comprising:
a first transparent substrate comprising a circuit structure formed thereon;
a plurality of LEDs mounted on the first transparent substrate and electrically connected to the circuit structure; and
a second transparent substrate covered on the LEDs.

2. The LED displaying device of claim 1, wherein the first transparent substrate comprises a main plate and a connecting interface at one periphery side thereof, the circuit structure comprising a plurality of circuit wires electrically connected between the connecting interface and the LEDs.

3. The LED displaying device of claim 2, wherein each of the circuit wires comprises a first end connected with the connecting interface and a second end connected with a corresponding LED, the first ends are equally spaced from each other, and distances between each two neighboring second ends are increased along a direction from a position adjacent to the connecting interface to a position distant from the connecting interface.

4. The LED displaying device of claim 3, wherein the circuit wires are parallel to each other.

5. The LED displaying device of claim 3, wherein the distance between each two neighboring second ends is larger than that of each two neighboring first ends.

6. The LED displaying device of claim 2, further comprising a drive unit electrically connected with the connecting interface of the first substrate and a control unit electrically connected with the drive unit, the control unit being configured to receive a signal containing displaying messages and output the signal to the drive unit, the drive unit receiving the signal and driving the LEDs to emit light in a controlled manner for displaying the displaying messages thereby.

7. The LED displaying device of claim 6, wherein the control unit receives the signal via wireless transmission.

8. The LED displaying device of claim 6, further comprising an AC-DC convertor electrically connected with the control unit, the AC-DC convertor being configured for converting an AC voltage to a DC voltage and supplying the DC voltage to the control unit.

9. The LED displaying device of claim 1, further comprising a fixing frame for connecting the first transparent substrate and the second transparent substrate together, the fixing frame comprising a first connecting wall and a second connecting wall connected with the first transparent substrate and the second transparent substrate, respectively.

10. The LED displaying device of claim 9, wherein the fixing frame comprises a first fixing plate defining a first engaging groove therein, a second fixing plate defining a second engaging groove therein and a plurality of fastening elements, each of the fastening elements comprising two engaging plates engaged in the first engaging groove and the second engaging groove, respectively.

11. The LED displaying device of claim 1, wherein the first transparent substrate and the second transparent substrate are made of the glass.

12. The LED displaying device of claim 11, wherein the circuit structure is made of conductive sliver paste, and formed on the first transparent substrate via screen printing.

13. The LED displaying device of claim 1, wherein an affixing layer is interconnected between the first transparent substrate and the second transparent substrate.

14. The LED display device of claim 3, wherein the first transparent substrate defines a receiving concave recessed from a surface thereof, and the LEDs are received in the receiving concave.

15. A method of manufacturing an LED displaying device, comprising:
providing a first transparent substrate with a circuit structure formed thereon via screen printing;
mounting a plurality of LEDs on the first transparent substrate and electrically connecting the LEDs to the circuit structure; and
providing a second transparent substrate and affixing the second transparent substrate to the first transparent substrate to cover the LEDs.

16. The method of claim 15, further comprising providing a drive unit electrically connected with the circuit structure of the first substrate and a control unit electrically connected with the drive unit, the control unit being configured to receive a signal containing displaying messages and output the signal to the drive unit, the drive unit receiving the signal and driving the LEDs to emit light in a controlled manner for displaying the displaying messages thereby.

17. The method of claim 16, wherein further comprising providing a fixing frame which comprises a first connecting wall and a second connecting wall connected with the first transparent substrate and the second transparent substrate, respectively, the fixing frame defining a receiving room for receiving the drive unit and the control unit therein.
